(19) United States
(12) Patent Application Publication
(10) Pub. No.: US 2009/0096422 A1
(43) Pub. Date: Apr. 16, 2009

(54) Charge Regulation Assembly And Method For Charging A Battery

(76) Inventor: Peter Trattler, Graz (AT)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/793,154

(22) PCT Filed: Dec. 14, 2005
(86) PCT No.: PCT/EP05/13468

§ 371 Date: Apr. 30, 2008

(30) Foreign Application Priority Data
Dec. 15, 2004 (DE) 102004060359.6

(51) Int. Cl. H02J 7/00; G05F 1/00

(52) U.S. Cl. 320/138; 323/273

(57) ABSTRACT

A charging regulator arrangement (30) and a method for charging a battery (13) are specified. Current elements (11, 12) are produced by a DC/DC converter (14) and a series regulator (24). A control unit (15) controls the DC/DC converter (14) and the series regulator (24) as a function of the actual charging current (I) of the battery. The power losses can be reduced when the chip area is reduced, and this makes it possible to lengthen the life of the battery (13) to be charged. The disclosed technique is suitable, for example, for use in mobile radios.

The present invention relates to a charging regulator arrangement, to its use and to a method for charging a battery.

Rechargeable batteries are also referred to as accumulators and are used, for example, to supply electrical power to portable appliances. Battery charging regulators are normally fed from a constant voltage source. A charging current is produced at the output of the charging regulator, and is controlled as a function of the battery state of charge.

Various requirements have to be taken into account when charging rechargeable batteries. For example, on the one hand, the time required to recharge the battery should be as short as possible. Particularly for mobile applications, the chip area required for the charging regulator arrangement should be as small as possible, preferably by the use of integrated design techniques. In addition, the electrical power losses must not exceed predeterminable limits.

Lithium-ion accumulators are used by preference in mobile radios, such as cellular telephones, because of their relatively high energy density and their relatively low weight, as well as the lack of any undesirable memory effect. Either linear regulators or so-called DC/DC converters are normally used for charging accumulators such as these. A DC/DC converter requires an inductance, because it generally operates on the basis of a clocked secondary, and this inductance is frequently in the form of a coil. However, in order to avoid the chip area and the physical form of the overall charging arrangement becoming excessively large, a relatively small coil is normally used. However, this can lead to the DC/DC converter not being able to charge the battery with the necessary charging current. Because this results in the coil being operated in a saturated form, the average power losses in the charging regulator with a small coil are relatively large, particularly during charging with a constant current.

The mean power loss of the charging regulator is also relatively high in the case of a linear regulator.

The problem with the power loss in the described charging regulator arrangements is, in particular, the fact that a high electrical power loss must be dissipated as heat losses. High heat losses in turn lead, however, to significant heating of the battery during the charging process. This in turn considerably reduces the life of the battery.

The object of the present invention is to specify a charging regulator arrangement, its use and a method for charging a battery, in which the electrical power losses from a predetermined area are reduced.

According to the invention, the object relating to the apparatus is achieved by a charging regulator apparatus having:
an input for connection to a voltage source,
an output designed for producing a battery charging current,
a DC/DC converter with an input which is connected to the input of the charging regulator arrangement, with an output which is connected to the output of the charging regulator arrangement, and with a control input,
a control unit with an input for supplying a signal which is dependent on the battery charging current, and with an output which is connected to the control input of the DC/DC converter, and
a series regulator which is connected between the input and the output of the charging regulator arrangement and has a control input which is connected to a further output of the control unit.

Advantageous developments of the charging regulator arrangement are the subject matter of the dependent claims.

With regard to the method, the object is achieved by a method for charging a battery, comprising the following steps:
producing a first charging current component for charging the battery by means of a DC/DC converter,
producing a second charging current component for charging the battery by means of a series regulator,
linking the first and the second charging current components to form a battery charging current,
controlling the first charging current component and the second charging current component as a function of the battery charging current.

Advantageous developments of the method are the subject matter of the dependent claims.

The expressions battery, rechargeable battery and accumulator are used synonymously in the present text.

It is within the scope of the present principle for a DC/DC converter and a series regulator to be combined with one another, by connecting them in parallel, in a charging regulator arrangement for charging a battery. Although an arrangement such as this initially requires more components, than if only a series regulator or only a DC/DC converter were provided, the proposed principle nevertheless makes it possible to produce considerably reduced power losses with the overall charging regulator arrangement having the same area, or conversely to integrate the proposed charging regulator arrangement in a considerably smaller required space for the same power losses, as explained in more detail in the following text.

The expression a DC/DC converter should preferably be understood as meaning a charging regulator with a clocked secondary. DC/DC converters such as these which are referred to as switched-mode regulators with clocked secondaries may, for example, be in the form of step-down converters. Switched-mode regulators with clocked secondaries each have four components according to the basic circuit, specifically two switches, a storage inductor and a smoothing capacitor. In this case, one of the two switches may be in the form of a diode.

Switched-mode regulators with clocked secondaries may be either in the form of forward converters or flyback converters.

In the present case, the expression a series regulator should preferably be understood as meaning a linear regulator, which in the simplest case may be in the form of a series transistor between the input and output of the charging regulator arrangement.

The DC/DC converter and the series regulator preferably each produce a charging current component, with the two current components being added at the output of the charging regulator arrangement.

In order to achieve as high an efficiency as possible and power losses which are as low as possible, the control unit which drives the DC/DC converter and the series regulator is preferably designed such that the basic load of the charging current is produced by the DC/DC converter. The control unit activates the series regulator only when and for as long as the current component produced by the DC/DC converter exceeds a predetermined threshold, in order to supply the current component that is still missing.

The actual input signal for the control unit is preferably produced by a means for charging current detection. The means for charging current detection is provided in an output current path between the output of the charging regulator arrangement and a reference-ground potential connection. The battery to be charged is also connected in this output current path. The means for charging current detection produces a signal which is dependent on the battery charging current, and transmits this signal to the control unit.

By way of example, the means for charging current detection may be in the form of a resistor in series with the battery, a so-called shunt resistor.

In addition or as an alternative to charging current detection, a means for charging voltage detection can be provided which couples the output of the charging regulator arrangement to an input of the control unit.

As already indicated, the series regulator may preferably comprise a transistor whose controlled path is connected between the input and the output of the series regulator and thus of the charging regulator arrangement and whose control connection forms the control input of the series regulator.

The control unit is preferably designed such that it emits a signal at a variable signal level in order to control the level of the current component produced at the output of the series regulator.

The DC/DC converter is advantageously in the form of a switched-mode regulator with a clocked secondary, preferably a step-down converter.

The step-down converter preferably comprises a series switch, having a first connection that is connected to the input of the charging regulator arrangement. The second connection of the series switch is connected to the reference-ground potential via a reverse-biased diode. Furthermore, the second connection of the series switch is connected to a connection of a series inductor downstream from the series switch. The series inductor is an inductance. The output connection of the series inductor is connected to the output of the charging regulator arrangement, and is connected to the reference-ground potential via an energy-storage capacitance.

The diode may also be in the form of a transistor, for example an n-channel metal oxide semiconductor, NMOS transistor.

The control unit is furthermore preferably designed such that it emits a signal with a variable duty ratio in order to control the level of the current component produced at the output of the DC/DC converter.

The proposed charging regulator arrangement may be designed such that it can be conductively connected to a voltage source at the input.

Alternatively or additionally, the charging regulator arrangement can be designed such that it can also be connected to the voltage source without the use of wires. This allows wire-free charging apparatuses to be provided, which do not require any charging cable.

The described charging regulator arrangement is preferably designed using integrated circuit technology, preferably using metal oxide semiconductor, MOS circuit technology.

Alternatively, the proposed charging regulator arrangement may be designed using bipolar or BiCMOS circuit technology.

The proposed charging regulator arrangement in mobile radios is preferably suitable for charging the accumulator of the mobile radio.

The proposed charging regulator arrangement is, however, not restricted to use in mobile radios, but can advantageously also be used in other applications.

In particular, the proposed charging regulator arrangement is suitable for charging lithium-ion batteries with low heat losses, for a long accumulator life. In this case, the charging regulator arrangement can be surrounded by the mobile radio housing, or may be in the form of an external appliance.

However, the proposed charging regulator arrangement is not restricted to charging batteries of the lithium-ion type, but can also be used advantageously for other types of batteries, such as lithium-polymer, nickel-metal-hydride or nickel-cadmium, etc.

Using the proposed charging regulator arrangement, a battery is preferably charged with an essentially constant charging current in a first charging phase. The battery is charged with an essentially constant charging voltage in a subsequent, second charging phase.

The common control unit for the series regulator and the DC/DC converter closes not only the control loop for the DC/DC converter but also the control loop for the series regulator in the proposed charging regulator arrangement.

The invention will be explained in more detail in the following text with reference to exemplary embodiments in a plurality of drawings, in which:

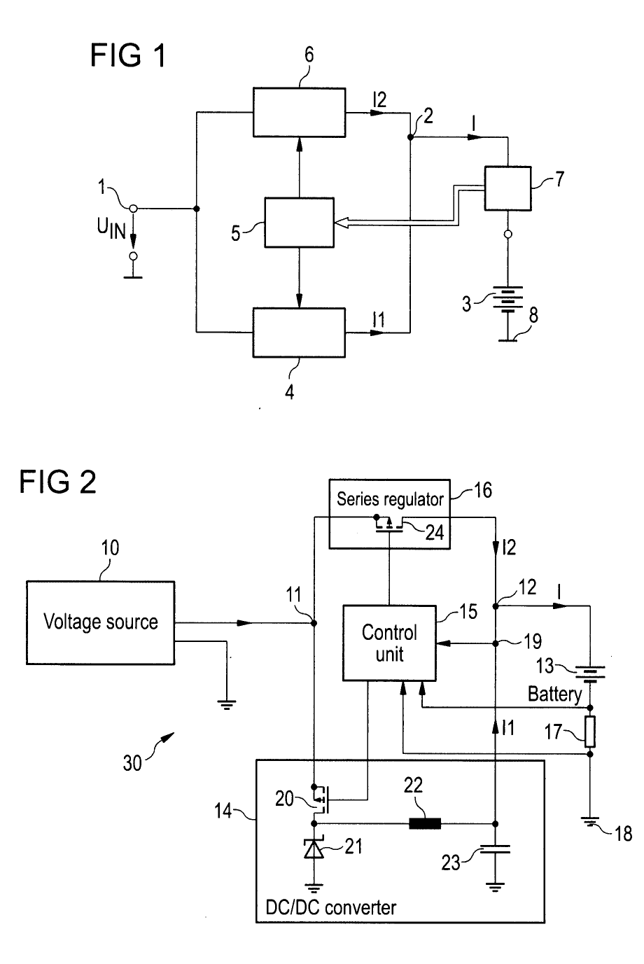

FIG. 1 shows a first exemplary embodiment of the proposed charging regulator arrangement, on the basis of an exemplary block diagram,

FIG. 2 shows a second exemplary embodiment of the proposed charging regulator arrangement, on the basis of an exemplary circuit diagram,

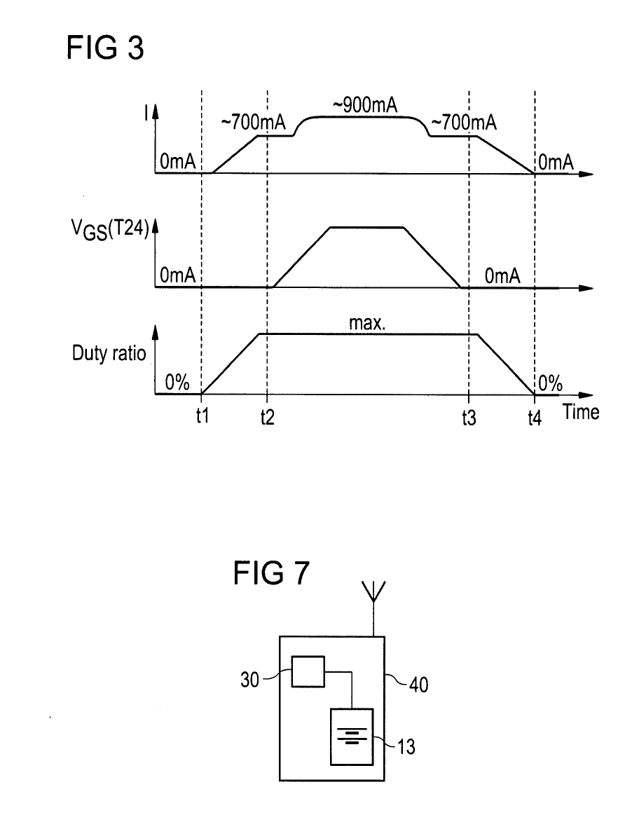

FIG. 3 shows the regulation principle of the proposed charging regulator on the basis of exemplary graphs,

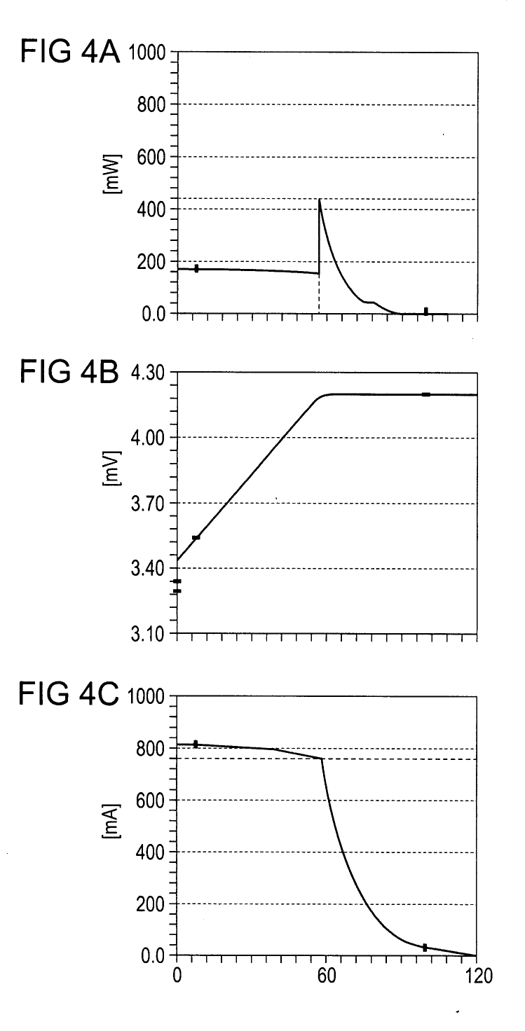

FIGS. 4a to 4c show the waveforms of the power loss, charging voltage and charging current of the proposed charging regulator arrangement, on the basis of exemplary graphs,

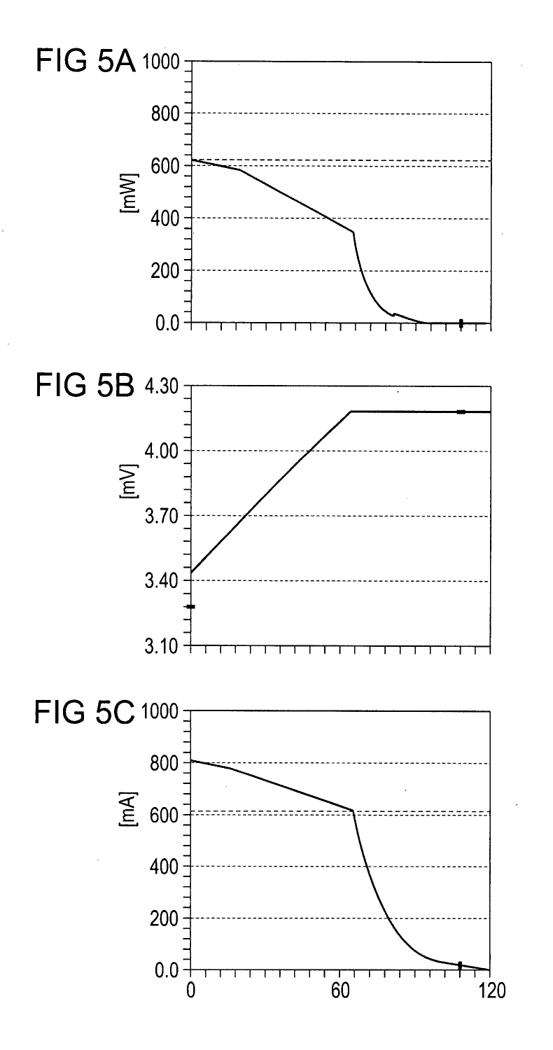

FIGS. 5a to 5c show the waveforms of the power loss, the charging voltage and the charging current for a conventional charging regulator just with a DC/DC converter, for the same dimension,

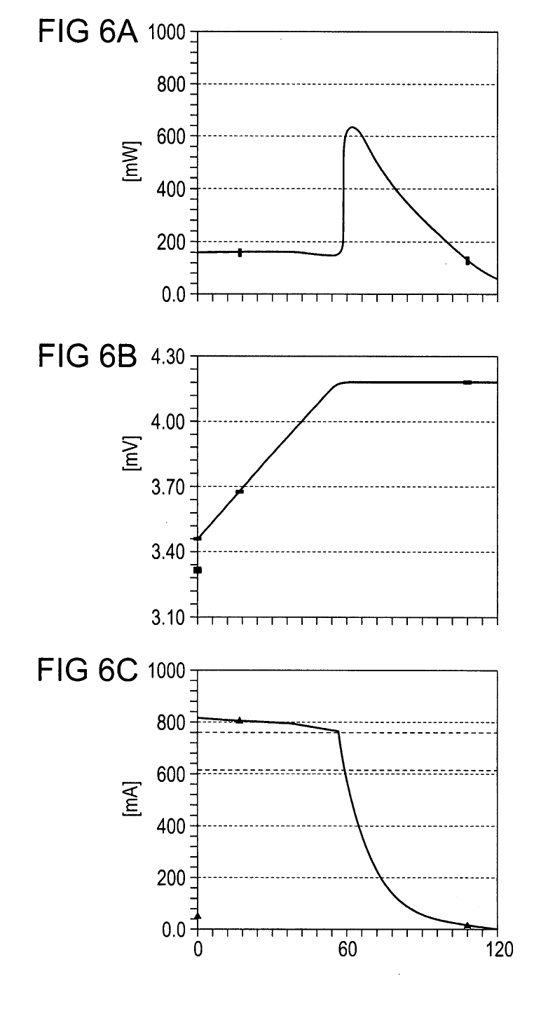

FIGS. 6a to 6c show the waveforms of the electrical power loss, the charging voltage and the charging current for a charging regulator exclusively in the form of a linear regulator, with the same dimension, and

FIG. 7 shows an example of the use of the charging regulator arrangement in a mobile radio.

FIG. 1 shows a charging regulator arrangement with an input 1 for connection to a voltage source and with an output 2 for production of a battery charging current I. The input 1 can be connected to a voltage source, which is not shown but produces a current-limited input voltage U_{IN}. The output 2 is designed for coupling to a rechargeable battery 3. The input of a DC/DC converter 4 is connected to the input 1 of the charging regulator arrangement, and its output is connected to the output 2 of the charging regulator arrangement. A control input of the DC/DC converter 4 is coupled to an output of a control unit 5. A further output of the control unit 5 is connected to a control input of a series regulator 6. The input of the series regulator 6 is connected to the input 1 of the charging regulator arrangement, and its output is connected to the output 2 of the charging regulator arrangement. Current elements I1, I2, produced by the DC/DC converter and the series regulator 4, 6, are additively linked in the output 2 of the charging regulator arrangement. Depending on the operating state, the current elements I1, I2 may be zero or may be other than zero. A means for charging current detection 7 is connected between the output 2 and a pole of the rechargeable battery 3. The means for charging current detection 7 is thus located in an output current path between the output 2 of the charging regulator arrangement and a reference-ground potential connection 8, which is connected to a further pole of the battery 3. One output of the means for charging current detection 7 is connected to one input of the control unit 5, in order to produce a signal which is dependent on the battery charging current.

Together with the means for charging current detection 7 and the control unit 5, the DC/DC converter 4 forms a first control loop. A further control loop is formed by the series regulator 6, the means for charging current detection 7 and the control unit 5.

The DC/DC converter 4 is used to produce the first charging current component I1 for charging the battery 3. The series regulator 6 is used to produce a second charging current component I2 for charging the battery 3. The first and the second charging current components I1, I2 are linked in the output 2 to form the battery charging current I. Both the first charging current component I1 and the second charging current component I2 are controlled by the control unit 5 as a function of the actual battery charging current I and of predetermined or predeterminable charging curve. The charging curve depends inter alia on the type of rechargeable battery 3, on the desired charging time, and/or on the maximum possible temperature during charging.

The control unit 5 may have means for storage of the predeterminable or predetermined charging curve.

FIG. 2 shows a further exemplary embodiment of a charging regulator arrangement based on the proposed principle. A current-limited voltage source 10 is connected to one input 11 of a charging regulator arrangement, in order to provide a supply voltage. On the one hand, a DC/DC converter 14 and, in parallel with it, a series regulator 16 are connected between the input 11 and an output 12 of the charging regulator arrangement. The output 12 is connected to one pole of a battery 13, and its other pole is connected to the reference-ground potential via a resistor 17. The resistor 17 is used as the means for charging current detection for the charging current I to the battery. The current elements I1 and I2 from the DC/DC converter and the series regulator 14, 16 are linked in the output 12 to form a battery charging current I. In addition to the means for charging current detection 17, which is connected to the inputs of the control unit 15, a means is provided for charging voltage detection 19, and connects the output 12 to a further input of the control unit 15. The control unit 15 has two outputs, which are connected to a respective control input of the DC/DC converter 14 and of the series regulator 16.

The DC/DC converter 14 is in the form of a switched-mode regulator with a clocked secondary, specifically in the form of a step-down converter. The input 11 is connected to a first circuit node via a first transistor 20. The first circuit node is connected on the one hand via a reverse-biased diode 21 to a reference-ground potential connection, and on the other hand via a coil 22 to the output 12. The output 12 is also connected via an energy storage capacitor 23 to the reference-ground potential.

The series regulator 16 is in the form of a linear regulator and comprises a second transistor 24, with a controlled path that is connected between the input 11 and the output 12 of the charging regulator arrangement. The gate connection of the transistor 24, in the same way as the gate connection of the first transistor 20, forms the control input of the series regulator and of the DC/DC converter.

The linear regulator 16 produces a second current element I2 which is dependent on a control voltage applied to the gate connection of the transistor 14. If the transistor 24 is in the form of an MOS transistor, the second current element I2 can be calculated, approximately, as:

I2≈k·(V_{GS}−V_{TH}) ²,

where I2 represents the second current element, k represents a constant, V_{GS} represents the gate-source voltage and V_{TH} represents the process-dependent threshold voltage of the transistor 24.

This provides the described relationship between the control signal and the charging current component I2.

As long as the switch 20 is closed, the voltage across the diode is equal to the input voltage to the converter. When the switch 20 is opened, the current produced by the inductor 22 remains in the same direction and the voltage dropped across the diode falls until the diode becomes forward-biased, that is to say, for example, it falls to zero potential. The waveform of the coil current of the coil 22 is obtained from the induction law, as:

$${U}_{L} = L \cdot \frac{d {I}_{L}}{d t}$$

In the time during which the switch 20 is switched on, the voltage across the coil is U_{L}, which is equal to the difference between the voltages U_{E} and U_{A}, where U_{E} is the input voltage to the converter and U_{A} is the output voltage from the converter across the capacitance 23. In the time during which the switch 20 is switched off, the output voltage across the inductance U_{L} is equal to −U_{A}. The change in the current through the inductance 22 is thus given by:

$$Δ {I}_{L} = \frac{1}{L} ( {U}_{E} - {U}_{A} ) \cdot {t}_{on} = \frac{1}{L} {U}_{A} \cdot {t}_{off}$$

The output voltage across the capacitance 23 can be calculated from this, as:

$${U}_{A} = \frac{{t}_{on}}{{t}_{on} + {t}_{off}} \cdot {U}_{E} = \frac{{t}_{on}}{T} \cdot {U}_{E} = p \cdot {U}_{E}$$

In this expression, the sum of the times tₒₙ, t_{off} for which the switch is switched on and off is the period T of oscillation, and p is the duty ratio. As can be seen, as expected, the output voltage is the arithmetic mean of the voltage across the diode 21. By way of example, in order to produce the switching signal for driving the switch 20, the control unit 15 may comprise a pulse-width modulator and a regulator with a voltage reference.

In alternative embodiments as shown in FIG. 1, for example, the battery 13 and the resistor 17 may be interchanged in the series circuit.

Alternatively, the diode 21 may also be in the form of a transistor.

The advantages of the proposed charging regulator arrangement, as shown in the exemplary embodiments in FIGS. 1 and 2, will be explained on the basis of the following graphs as shown in FIGS. 3 to 6c.

FIG. 3 shows the control principle on the basis of which the control units 5 in FIGS. 1 and 15 in FIG. 2, for example, can operate. FIG. 3 shows three graphs, arranged one above the other, showing, from top to bottom, the charging current I of the battery, the control signal for the series regulator 6, specifically the gate-source voltage V_{GS} of the transistor 24 in FIG. 2, and the duty ratio as the control signal for the DC/DC converter, in each case plotted against time. The charging regulator is switched off from the time zero to the time t1. As the desired battery charging current I increases, the duty ratio is increased linearly between the time t1 and the time t2. The duty ratio is increased up to the maximum that can be set.

If an even higher charging current is required, then this is done by additional connection or stepping-up of the series regulator, as can be seen in the central graph between the time t2 and the maximum series regulator control value that can be set. After a plateau phase, the battery charging current I is reduced again, in the example. In this case, the series regulator is firstly stepped down until the current becomes zero, with the duty ratio being left at the maximum value that can be set, at the same time. Only when the current demand is reduced further is the duty ratio of the DC/DC converter also reduced to zero, between the time t3 and the time t4. By way of example, the upper graph in FIG. 3 shows charging currents, specifically while the charging current is being increased with the maximum duty ratio of about 700 milliamperes, with the series regulator additionally completely open to produce a total charging current of 900 milliamperes, and 700 milliamperes once again after the series regulator has been stepped down, ending in a switched-off current of 0 milliamperes after the duty ratio has been reduced.

This principle as shown in FIG. 3 can be combined such that the DC/DC converter supplies the basic load as the battery charging current, and such that the series regulator is activated only at the level and for as long as the charging current element from the DC/DC converter is not sufficient to allow the desired total charging current I to be produced.

FIGS. 4a to 6c explain the advantages of the proposed charging regulator arrangement in comparison to conventional charging regulator arrangements. FIGS. 4a to 4c show in the left-hand column, from top to bottom, the power loss plotted against time, the charging voltage plotted against time, and the charging current plotted against time for a charging regulator arrangement based on the proposed principle.

In the center column, from top to bottom, FIGS. 5a to 5c likewise show the power loss, the charging voltage and the charging current, in each case plotted against a time axis. However, FIGS. 5a to 5c in this case relate to a charging regulator arrangement in which, in comparison to the proposed charging regulator arrangement, the series regulator has been omitted so that the entire charging current is produced by a DC/DC converter, whose dimension is the same as that shown in FIGS. 4a to 4c.

Finally, FIGS. 6a to 6c show, likewise in the form of graphs plotted against time, from top to bottom, the power loss in the charger, the charging voltage and the charging current, in each case for an arrangement in which, in comparison to the arrangement according to the invention, the DC/DC converter has been omitted so that the entire charging current is produced by the series regulator. The dimensioning of the series regulator in this case corresponds to that of the series regulator which is also shown in FIGS. 4a to 4c.

As can be seen from all of the graphs 4a to 6c, a constant charging current is used up to a time period of, for example, 60 minutes. The first charging phase is followed by a second charging phase, in which charging is carried out with a constant voltage.

All of the graphs 4a to 6c therefore each show a charging cycle for a battery to be charged.

A comparison of FIGS. 4a and 5a with one another shows that, in the second charging phase with a constant voltage, the DC/DC converter on its own, as shown in FIG. 5a, has a similar power loss waveform to the proposed charging regulator arrangement as shown in FIG. 4a. In contrast, in the first charging phase with a constant current, the coil in FIG. 5a must be operated to beyond saturation, and this leads to undesirably high power losses in the constant current area. This could admittedly be avoided by undesirably enlarging the coil, although this would lead to an undesirable chip area, as a result of the known large integration areas of coils. In contrast, FIG. 4a also shows a low power loss in the first charging phase.

If FIG. 4a is now compared with FIG. 6a, then it can be seen that the series regulator on its own admittedly offers a low power loss, similar to the combination as shown in FIG. 4a, in the constant-current charging area. However, charging with a constant voltage is problematic in FIG. 6a in which not only is there a high peak power loss after switching from constant current to constant voltage, but this is also followed overall by a high average power loss in comparison to which, as shown in FIG. 4a, the power loss is considerably reduced.

The proposed charging regulator arrangement admittedly requires additional components in comparison to a series regulator on its own or a DC/DC converter on its own. However, the proposed interconnection advantageously makes it possible to achieve a smaller chip area overall, despite the additional components, since, in particular, the coil for the DC/DC converter can be designed to be considerably smaller. Furthermore, the reduced power losses of the entire charging regulator as shown result in considerably reduced heat losses, which in turn leads to a longer battery life.

The proposed combination of a DC/DC converter with a series regulator in a charging regulator arrangement accordingly offers, as can be seen in FIGS. 4a to 4c, a very low average power loss, which results in a longer battery life, as well as a reduction in the peak power loss, so that, overall, it is possible to use components with a smaller component size, which therefore also occupy a smaller area.

Finally, FIG. 7 shows an example of the use of the charging regulator arrangement as shown in FIG. 2, in a mobile radio 40. In this case, the charging regulator arrangement 30 is coupled to a rechargeable battery 13. In the exemplary embodiment shown in FIG. 7, the rechargeable battery is in the form of a lithium-ion accumulator. The proposed charging regulator arrangement is particularly suitable for use in mobile radios as a result of the explained advantages, such as a longer battery life as a result of lower power losses during charging as well as a smaller overall area and smaller component sizes.

The proposed charging regulator arrangement may, of course, also be used advantageously in other mobile appliances or permanently installed appliances. The charging regulator arrangement is likewise suitable for charging other battery types than lithium-ion accumulators, such as nickel-metal-hydride, NiMH accumulators, nickel-cadmium, NiCD accumulators, and lithium-polymer, LiPo accumulators.

Instead of the series regulator in the form of a linear regulator with only one transistor, as is shown in FIG. 2, other linear regulators based on the proposed principle can also be used.

The illustrated exemplary embodiments are not intended to be used for the purpose of restricting the general idea of the invention but in fact to be used as exemplary embodiments for explanation and illustration of the method of operation of the proposed principle. Within the scope of the invention, a person skilled in the art can also combine the illustrated features in a manner other than that shown, as well, or can modify them within the scope of normal use.

For example, the MOS transistors and/or diodes shown in FIG. 2 may be replaced by bipolar transistors. Other integration techniques are also possible within the scope of the invention.

1.-23. (canceled)

24. A charging regulator arrangement, comprising:
an input for connection to a voltage source;
an output designed for producing a battery charging current;
a DC/DC converter with an input which is connected to the input of the charging regulator arrangement, with an output which is connected to the output of the charging regulator arrangement, and with a control input;
a control unit with an input for supplying a signal which is dependent on the battery charging current, and with an output which is connected to the control input of the DC/DC converter; and
a series regulator which is connected between the input and the output of the charging regulator arrangement and has a control input which is connected to a further output of the control unit;
wherein the series regulator comprises an MOS transistor having a controlled path that is connected between the input and the output of the series regulator and a control connection that forms the control input of the series regulator.

25. The charging regulator arrangement as claimed in claim 24, wherein the control unit is designed to activate the series regulator only when and for as long as a current component produced by the DC/DC converter reaches a predetermined threshold.

26. The charging regulator arrangement as claimed in claim 24, further comprising means for charging current detection in an output current path between the output of the charging regulator arrangement and a reference-ground potential connection and is connected to the control unit in order to produce the signal which is dependent on the battery charging current.

27. The charging regulator arrangement as claimed in claim 24, wherein the means for charging current detection is a shunt resistor (17).

28. The charging regulator arrangement as claimed in claim 24, further comprising means for charging voltage detection, which couples the output of the charging regulator arrangement to an input of the control unit.

29. The charging regulator arrangement as claimed in claim 24, wherein the series regulator (16) is a linear regulator.

30. The charging regulator arrangement as claimed in claim 24, wherein the control unit is designed to emit a signal at a variable signal level in order to control the level of the current component produced at the output of the series regulator.

31. The charging regulator arrangement as claimed in claim 24, wherein the DC/DC converter is in the form of a switched-mode regulator with a clocked second rate.

32. The charging regulator arrangement as claimed in claim 24, wherein the DC/DC converter is in the form of a step-down converter.

33. The charging regulator arrangement as claimed in claim 32, wherein the step-down converter comprises a series switch with a diode on the output side to the reference-ground potential, and a downstream series inductor with an energy-storage capacitance on the output side.

34. The charging regulator arrangement as claimed in claim 33, wherein the diode is in the form of a transistor.

35. The charging regulator arrangement as claimed in claim 24, wherein the control unit is designed to emit a signal with a variable duty ratio in order to control the level of the current component produced at the output of the DC/DC converter.

36. The charging regulator arrangement as claimed in claim 24, wherein the input of the charging regulator arrangement can be conductively connected to the voltage source.

37. The charging regulator arrangement as claimed in claim 24, wherein the input of the charging regulator arrangement is adapted to be connected to the voltage source without the use of wires.

38. The charging regulator arrangement as claimed in claim 24, wherein the charging regulator arrangement is designed using integrated circuit technology.

39. A mobile radio comprising the charging regulator arrangement as claimed in claim 24.

40. Apparatus for sharing a lithium-ion battery comprising the charging regulator arrangement as claimed in claim 24.

41. A method for charging a battery, comprising the steps of:
producing a first charging current component for charging the battery by means of a DC/DC converter;
producing a second charging current component for charging the battery by means of a series regulator;
linking the first and the second charging current components to form a battery charging current; and
controlling the first charging current component and the second charging current component as a function of the battery charging current.

42. The method as claimed in claim 41, wherein the second charging current component is provided only when and for as long as the first charging current component reaches a predetermined threshold.

43. The method as claimed in claim 41, further comprising detecting the battery charging current.

44. The method as claimed in claim 41, further comprising detecting the battery charging voltage and controlling the first and the second charging current component as a function of the battery charging voltage.

45. The method as claimed in claim 41, further comprising:
charging the battery in a first charging phase with an essentially constant charging current; and
charging the battery in a second charging phase, following the first, with an essentially constant charging voltage.
